(19) United States
(12) Patent Application Publication
(10) Pub. No.: US 2026/0280838 A1
(43) Pub. Date: Sep. 17, 2026

(54) HALF-DUPLEX DATA COMMUNICATION SYSTEM

(71) Applicant: NOREL SYSTEMS LIMITED, Tianjin (CN)

(72) Inventors: Yuanlong Wang, Tianjin (CN); Ke Liang, Tianjin (CN)

(21) Appl. No.: 19/674,252

(22) Filed: May 12, 2026

Related U.S. Application Data
(63) Continuation of application No. PCT/CN2025/098142, filed on May 29, 2025.

(30) Foreign Application Priority Data
Aug. 5, 2024 (CN) 202411062894.7

(51) Int. Cl. H04L 5/16; H04J 3/06

(52) U.S. Cl. CPC H04L 5/16; H04J 3/0667

(57) ABSTRACT

A half-duplex data communication system includes a first communication device and a second communication device. The first communication device is connected to the second communication device via a communication link. The first communication device sends a first signal to the second communication device. The second communication device sends a second signal to the first communication device. The first signal includes a synchronization frame. The second communication device recovers a data frame synchronization signal according to the received synchronization frame, and communicates with an external device based on the data frame synchronization signal. A local clock generation module in the second communication device generates a local clock of the second communication device, the clock for the second communication device to send the second signal is the local clock of the second communication device, and the first signal and the second signal are transmitted on the communication link in a time-division manner.

### CROSS-REFERENCE TO RELATED APPLICATION

This application ‎is a continuation application of International Patent Application No. ‎PCT/CN2025/098142, filed on May 29, 2025, which itself claims priority to and benefit ‎of Chinese Patent Application No. 202411062894.7, filed on August 5, 2024 in the State ‎Intellectual Property Office of P. R. China. The disclosure of each of the above applications ‎is incorporated herein by reference in its entirety.‎

### TECHNICAL FIELD

The present invention relates to the technical field of communication, and in particular, to a half-duplex data communication system.

### BACKGROUND ART

In a vehicle-mounted audio transmission system, a daisy-chain topology structure is often adopted to connect various communication devices (nodes) for simplifying the wiring harness design, and multiple communication devices may be included on a transmission link, for example, a first communication device is connected to a second communication device, and the second communication device is connected to a third communication device, where each communication device is respectively connected to its own external device or peripheral module such as a processor, a microphone, a power amplifier and the like.

When the first communication device needs to send data to the third communication device, the data can be first sent to the second communication device, and then sent to the third communication device by the second communication device; the second communication device can also receive data from the external device connected thereto and send the data to the third communication device.

To save wires, there is often no dedicated clock line for transmitting clock signals in a vehicle-mounted audio transmission system. At present, a time-division transmission method is often adopted in a vehicle-mounted audio transmission system to transmit audio data, where one or more audio sampling points are transmitted in each time slot, and the data transmission of the system between time slots may be discontinuous, that is, a clock recovery circuit cannot rely on the continuous transmission of data, and a method similar to protocols such as PCIe and USB 3.0 cannot be adopted for clock recovery.

In a vehicle-mounted audio transmission system including a first communication device, a second communication device, a third communication device and other multiple communication devices in sequence on a transmission link, a method adopted for clock recovery and data transmission is as follows: the first communication device sends data to the second communication device, the second communication device recovers and receives a clock and data (clock data recovery) based on the received data, and uses the recovered clock as a transmission clock to send data to the third communication device; the third communication device also recovers and receives the clock and data (clock data recovery) based on the received data after receiving the data, and uses the recovered clock as the transmission clock.

With this method, the clock generated after clock recovery has a certain jitter, and the clock of a latter-stage communication device on the transmission link has a larger clock jitter than that of a former-stage communication device, thus having a larger phase noise. When there are many stages of communication devices on the transmission link, the clock phase noise of the last-stage communication device is large, making it difficult to sample data correctly and leading to a high bit error rate.

In a vehicle-mounted audio transmission system including a first communication device, a second communication device, a third communication device and other multiple communication devices in sequence on a transmission link, a second method adopted for clock recovery and data transmission is as follows: the first communication device sends data to the second communication device, the second communication device recovers and receives a clock and data (clock data recovery) based on the received data; the second communication device adopts a local clock generation circuit to generate a transmission clock for sending data to the third communication device, and the transmission clock does not depend on the data received by the second communication device from the first communication device.

With this method, the clock phase noise of the latter-stage communication device does not increase with the increase in the number of stages of communication devices, and the bit error rate is low. However, an audio sampling signal of audio data, which includes a sampling frequency and a phase, still needs to be transmitted for an audio system.

At present, there is a lack of a transmission system and method in which the clock phase noise does not increase with the increase in the number of stages of communication devices in the transmission system, the bit error rate is low, and the data sampling frequency and phase can be transmitted.

### SUMMARY

The technical problem to be solved by the present invention is how to make the clock phase noise not increase with the increase in the number of stages of communication devices in the transmission system, and at the same time, enable the system to transmit audio data with multiple sampling frequencies.

To solve the above technical problem, the technical solution adopted by the present invention is as follows:

As a slave communication device of the present invention, it includes an upstream device interface module, a data frame synchronization signal(DFSS) recovery module, a local clock generation module and a peripheral interface module. The upstream device interface module is connected to an upstream device via an uplink, the upstream device sends a first signal, the upstream device interface module receives the first signal from the upstream device via the uplink, and the upstream device interface module sends a second signal to the upstream device via the uplink. The first signal includes a synchronization frame(SF), and the upstream device interface module receives the synchronization frame. The data frame synchronization signal recovery module is connected to the upstream device interface module, and recovers a data frame synchronization signal according to the received synchronization frame. The local clock generation module generates a first local clock, the clock for the upstream device interface module to send the second signal is the first local clock, and the first signal and the second signal are transmitted on the uplink in a time-division manner.

Preferably, the slave communication device further includes a downstream device interface module, which is connected to a downstream device via a downlink, sends a third signal to the downstream device via the downlink, and receives a fourth signal from the downstream device via the downlink. The slave communication device sends the received synchronization frame to the downstream device by including the synchronization frame in the third signal via the downlink. The local clock generation module further generates a second local clock, the clock for the downstream device interface module to send the third signal is the second local clock, and the third signal and the fourth signal are transmitted on the downlink in a time-division manner.

Preferably, the peripheral interface module is connected to an external device, and the peripheral interface module communicates with the external device based on the data frame synchronization signal, including that the peripheral interface module sends data to the external device, or receives data from the external device, or sends data to the external device and receives data from the external device based on the data frame synchronization signal; and may also include that the peripheral interface module sends the data frame synchronization signal to the external device.

Preferably, the slave communication device is an integrated circuit chip, the local clock generation module generates the first local clock according to a local reference clock, and the local reference clock is generated by an on-chip crystal-free reference clock generation circuit of the integrated circuit chip.

Preferably, the slave communication device is an integrated circuit chip, the local clock generation module generates the first local clock and the second local clock according to a local reference clock, and the local reference clock is generated by an on-chip crystal-free reference clock generation circuit of the integrated circuit chip.

Preferably, the ratio of the frame frequency of the synchronization frame to the frequency of the data frame synchronization signal is M/N, where M and N are both positive integers, and the data frame synchronization signal recovery module recovers the data frame synchronization signal according to the timing signal of the received synchronization frame.

Further, the synchronization frame includes a sequence number field, the sequence number field contains a sequence number of the synchronization frame, and the data frame synchronization signal recovery module recovers the data frame synchronization signal according to the sequence number field and the timing signal of the received synchronization frame.

Preferably, the synchronization frame includes a phase field, the phase field contains phase relationship information between the synchronization frame and the data frame synchronization signal, and the data frame synchronization signal recovery module recovers the data frame synchronization signal according to the phase field.

Preferably, the synchronization frame includes a phase field and a counting field, the phase field contains phase relationship information between the synchronization frame and the data frame synchronization signal, the counting field contains a count value of the data frame synchronization signal, and the data frame synchronization signal recovery module recovers the data frame synchronization signal according to the phase field and the counting field.

Further, the frame frequency of the synchronization frame is independent of the frequency of the data frame synchronization signal.

Preferably, the first signal further includes a first data frame, and the slave communication device receives the first data frame and sends part or all of the data contained in the first data frame to the external device.

Preferably, the first signal further includes a first data frame, the third signal includes a third data frame, and the slave communication device receives the first data frame and sends part or all of the data contained in the first data frame to the downstream device by including the data in the third data frame.

Preferably, the peripheral interface module is connected to an external device, the third signal includes a third data frame, and the slave communication device receives data from the external device and sends part or all of the data to the downstream device by including the data in the third data frame.

Preferably, the peripheral interface module is connected to an external device, the first signal further includes a first data frame, the third signal includes a third data frame, the slave communication device receives the first data frame and data from the external device, and sends part or all of the data contained in the first data frame and part or all of the data received from the external device to the downstream device by including the data in the third data frame.

Preferably, the peripheral interface module is connected to an external device, the fourth signal includes a fourth data frame, and the slave communication device receives the fourth data frame and sends part or all of the data contained in the fourth data frame to the external device.

Preferably, the second signal includes a second data frame, the fourth signal includes a fourth data frame, and the slave communication device receives the fourth data frame and sends part or all of the data contained in the fourth data frame to the upstream device by including the data in the second data frame.

Preferably, the second signal includes a second data frame, and the slave communication device receives data from the external device and sends part or all of the data to the upstream device by including the data in the second data frame.

Preferably, the peripheral interface module is connected to an external device, the second signal includes a second data frame, the fourth signal includes a fourth data frame, the slave communication device receives the fourth data frame and data from the external device, and sends part or all of the data contained in the fourth data frame and part or all of the data received from the external device to the upstream device by including the data in the second data frame.

Preferably, the second signal includes a synchronization response frame(SRF), and the upstream device interface module sends the synchronization response frame to the upstream device within a preset time after receiving the synchronization frame.

Further, after receiving the synchronization frame, the upstream device interface module sends the synchronization response frame to the upstream device earlier than any other data sent to the upstream device.

Preferably, the fourth signal includes a synchronization response frame, and after sending the synchronization frame included in the third signal, the slave communication device judges the state of the downlink according to whether the synchronization response frame included in the fourth signal is received within a preset time.

As a master communication device of the present invention, it includes a host interface module, a downstream device interface module and a local clock generation module. The host interface module is connected to a host, and receives a data frame synchronization signal from the host. The downstream device interface module is connected to a downstream device via a downlink, sends a first signal to the downstream device via the downlink, the downstream device sends a second signal, and the downstream device interface module receives the second signal from the downstream device via the downlink. The first signal includes a synchronization frame, the downstream device interface module sends the synchronization frame, the synchronization frame contains data frame synchronization signal information, and the downstream device can recover the data frame synchronization signal according to the synchronization frame. The local clock generation module generates a local clock, the clock for the downstream device interface module to send the first signal is the local clock, and the first signal and the second signal are transmitted on the downlink in a time-division manner.

Preferably, the ratio of the frame frequency of the synchronization frame to the frequency of the data frame synchronization signal is M/N, where M and N are both positive integers.

Further, the synchronization frame includes a sequence number field, and the sequence number field contains a sequence number of the synchronization frame.

Preferably, the synchronization frame includes a phase field, and the phase field contains phase relationship information between the synchronization frame and the data frame synchronization signal.

Preferably, the synchronization frame includes a phase field and a counting field, the phase field contains phase relationship information between the synchronization frame and the data frame synchronization signal, and the counting field contains a count value of the data frame synchronization signal.

Further, the frame frequency of the synchronization frame is independent of the frequency of the data frame synchronization signal.

Preferably, the first signal includes a first data frame, and the master communication device receives data from the host and sends part or all of the data to the downstream device by including the data in the first data frame.

Preferably, the second signal includes a second data frame, and the master communication device receives the second data frame and sends part or all of the data contained in the second data frame to the host.

Preferably, the master communication device does not send any data to the downstream device within a preset time after sending the synchronization frame.

Preferably, the second signal includes a synchronization response frame, and after sending the synchronization frame, the master communication device judges the state of the downlink according to whether the synchronization response frame is received within a preset time.

Preferably, the master communication device is an integrated circuit chip, the local clock generation module generates the local clock according to a local reference clock, and the local reference clock is generated by an on-chip crystal-free reference clock generation circuit of the integrated circuit chip.

As another master communication device of the present invention, it includes a downstream device interface module, a data frame synchronization signal generation module and a local clock generation module. The data frame synchronization signal generation module generates a data frame synchronization signal. The downstream device interface module is connected to a downstream device via a downlink, sends a first signal to the downstream device via the downlink, the downstream device sends a second signal, and the downstream device interface module receives the second signal from the downstream device via the downlink. The first signal includes a synchronization frame, the downstream device interface module sends the synchronization frame, the synchronization frame contains data frame synchronization signal information, and the downstream device can recover the data frame synchronization signal according to the synchronization frame. The local clock generation module generates a local clock, the clock for the downstream device interface module to send the first signal is the local clock, and the first signal and the second signal are transmitted on the downlink in a time-division manner.

Preferably, the ratio of the frame frequency of the synchronization frame to the frequency of the data frame synchronization signal is M/N, where M and N are both positive integers.

Further, the synchronization frame includes a sequence number field, and the sequence number field contains a sequence number of the synchronization frame.

Preferably, the synchronization frame includes a phase field, and the phase field contains phase relationship information between the synchronization frame and the data frame synchronization signal.

Preferably, the synchronization frame includes a phase field and a counting field, the phase field contains phase relationship information between the synchronization frame and the data frame synchronization signal, and the counting field contains a count value of the data frame synchronization signal.

Further, the frame frequency of the synchronization frame is independent of the frequency of the data frame synchronization signal.

Preferably, the first signal includes a first data frame, the master communication device generates data based on the data frame synchronization signal, and sends the generated data to the downstream device by including the data in the first data frame.

Preferably, the second signal includes a second data frame, and the master communication device receives the second data frame.

Preferably, the master communication device further includes a host interface module, which is connected to a host and sends the data frame synchronization signal to the host.

Further, the first signal includes a first data frame, the host generates data based on the data frame synchronization signal, and the master communication device receives data from the host and sends part or all of the data to the downstream device by including the data in the first data frame. The second signal includes a second data frame, and the master communication device receives the second data frame and sends part or all of the data contained in the second data frame to the host.

Preferably, the master communication device does not send any data to the downstream device within a preset time after sending the synchronization frame.

Preferably, the second signal includes a synchronization response frame, and after sending the synchronization frame, the master communication device judges the state of the downlink according to whether the synchronization response frame is received within a preset time.

Preferably, the master communication device is an integrated circuit chip, the local clock generation module generates the local clock according to a local reference clock, and the local reference clock is generated by an on-chip crystal-free reference clock generation circuit of the integrated circuit chip.

As a half-duplex data communication system of the present invention, it includes a first communication device and a second communication device, where the first communication device is connected to the second communication device via a communication link. The first communication device includes a downstream device interface module, which sends a first signal to the second communication device via the communication link and receives a second signal from the second communication device via the communication link. The second communication device includes an upstream device interface module, which sends the second signal to the first communication device via the communication link and receives the first signal from the first communication device via the communication link. The first signal includes a synchronization frame, and the second communication device receives the synchronization frame. The second communication device further includes a data frame synchronization signal recovery module, which recovers a data frame synchronization signal according to the received synchronization frame. The first communication device and the second communication device each further include a local clock generation module, the clock for the first communication device to send the first signal is a local clock of the first communication device generated by the local clock generation module included in the first communication device, the clock for the second communication device to send the second signal is a local clock of the second communication device generated by the local clock generation module included in the second communication device, and the first signal and the second signal are transmitted on the communication link in a time-division manner.

Preferably, the first communication device is a master communication device, and the second communication device is a slave communication device.

Further, the first communication device does not send any data to the downstream device within a preset time after sending the synchronization frame.

Preferably, both the first communication device and the second communication device are slave communication devices.

Preferably, the second communication device further includes a peripheral interface module, which is connected to an external device and communicates with the external device based on the data frame synchronization signal.

Further, the peripheral interface module communicating with the external device based on the data frame synchronization signal includes that the peripheral interface module sends data to the external device, or receives data from the external device, or sends data to the external device and receives data from the external device based on the data frame synchronization signal; and may also include that the peripheral interface module sends the data frame synchronization signal to the external device.

Preferably, the second signal includes a synchronization response frame, and the second communication device sends the synchronization response frame to the first communication device within a preset time after receiving the synchronization frame.

Further, after receiving the synchronization frame, the second communication device sends the synchronization response frame to the first communication device earlier than any other data sent to the first communication device. After sending the synchronization frame included in the first signal, the first communication device judges the state of the communication link according to whether the synchronization response frame included in the second signal is received within a preset time.

Preferably, the ratio of the frame frequency of the synchronization frame to the frequency of the data frame synchronization signal is M/N, where M and N are both positive integers, and the data frame synchronization signal recovery module recovers the data frame synchronization signal according to the timing signal of the received synchronization frame.

Further, the synchronization frame includes a sequence number field, the sequence number field contains a sequence number of the synchronization frame, and the data frame synchronization signal recovery module recovers the data frame synchronization signal according to the sequence number field and the timing signal of the received synchronization frame.

Preferably, the synchronization frame includes a phase field, the phase field contains phase relationship information between the synchronization frame and the data frame synchronization signal, and the data frame synchronization signal recovery module recovers the data frame synchronization signal according to the phase field.

Preferably, the synchronization frame includes a phase field and a counting field, the phase field contains phase relationship information between the synchronization frame and the data frame synchronization signal, the counting field contains a count value of the data frame synchronization signal, and the data frame synchronization signal recovery module recovers the data frame synchronization signal according to the phase field and the counting field.

Further, the frame frequency of the synchronization frame is independent of the frequency of the data frame synchronization signal.

Preferably, the first communication device is an integrated circuit chip, the local clock generation module included in the first communication device generates the local clock of the first communication device according to a local reference clock of the first communication device, and the local reference clock of the first communication device is generated by an on-chip crystal-free reference clock generation circuit of the integrated circuit chip included in the first communication device.

Preferably, the second communication device is an integrated circuit chip, the local clock generation module included in the second communication device generates the local clock of the second communication device according to a local reference clock of the second communication device, and the local reference clock of the second communication device is generated by an on-chip crystal-free reference clock generation circuit of the integrated circuit chip included in the second communication device.

The present invention provides a half-duplex data communication system, which makes the clock phase noise not increase with the increase in the number of stages of communication devices in the transmission system, and enables the system to transmit audio data with multiple sampling frequencies, thus the transmission system has a low bit error rate and good compatibility.

### BRIEF DESCRIPTION OF THE DRAWINGS

To explain the specific embodiments of the present invention or the technical solutions in the prior art more clearly, the drawings required for the specific embodiments or the description of the prior art will be briefly introduced below. Obviously, the drawings in the following description are some embodiments of the present invention, and those skilled in the art can obtain other drawings according to these drawings without creative work.

FIG. 1 is a schematic diagram of a half-duplex data communication system of the present invention;

FIG. 2 is a structural block diagram of a master communication system in the half-duplex data communication system of the present invention;

FIG. 3 is a structural block diagram of another master communication system in the half-duplex data communication system of the present invention;

FIG. 4 is a structural block diagram of a slave communication system in the half-duplex data communication system of the present invention;

FIG. 5 is a structural block diagram of another slave communication system in the half-duplex data communication system of the present invention;

FIG. 6 is a schematic diagram of a first signal, a second signal, a third signal and a fourth signal in the half-duplex data communication system of the present invention;

FIG. 7 is a structural diagram of a data frame in the half-duplex data communication system of the present invention;

FIG. 8 is a master-slave structural diagram of the half-duplex data communication system of the present invention;

FIG. 9 is a slave-slave structural diagram of the half-duplex data communication system of the present invention;

FIG. 10 is a signal timing diagram of a method for recovering a data frame synchronization signal in the half-duplex data communication system of the present invention;

FIG. 11 is a structural diagram of a synchronization frame in the half-duplex data communication system of the present invention;

FIG. 12 is a signal timing diagram of another method for recovering a data frame synchronization signal in the half-duplex data communication system of the present invention;

FIG. 13 is another structural diagram of a synchronization frame in the half-duplex data communication system of the present invention;

FIG. 14 is a signal timing diagram of a further method for recovering a data frame synchronization signal in the half-duplex data communication system of the present invention;

FIG. 15 is a further structural diagram of a synchronization frame in the half-duplex data communication system of the present invention;

FIG. 16 is a signal timing diagram of a still further method for recovering a data frame synchronization signal in the half-duplex data communication system of the present invention.

Reference numerals:

10: Master communication device

11: Slave communication device

100: Downstream device interface module in the master communication device

101: Local clock generation module in the master communication device

102: Host interface module

103: Data frame synchronization signal generation module

110: Upstream device interface module

111: Local clock generation module in the slave communication device

112: Peripheral interface module

113: Data frame synchronization signal recovery module

114: Downstream device interface module in the slave communication device

### DETAILED DESCRIPTION OF THE EMBODIMENTS

To make the above and other features and advantages of the present invention clearer, the present invention will be further described below with reference to the accompanying drawings. It should be understood that the specific embodiments provided herein are for the purpose of explaining to those skilled in the art, and are merely exemplary and not restrictive.

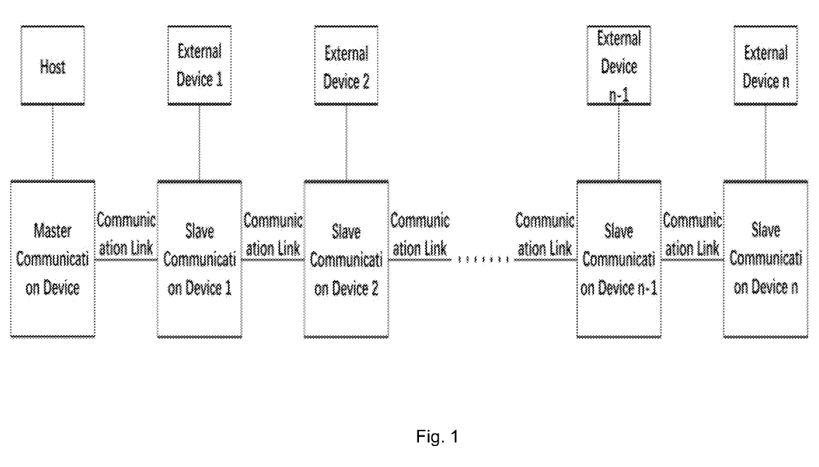

As shown in FIG. 1, as a half-duplex data communication system of the present invention, it includes a master communication device and one or more slave communication devices, where the master communication device can be optionally connected to a host, and the other communication devices are slave communication devices. Each communication device is connected in a daisy-chain topology structure, the master communication device is connected to a first slave communication device via a communication link, the first slave communication device is connected to a second slave communication device via a communication link, …, and a penultimate slave communication device is connected to a last slave communication device via a communication link.

In the present invention, the slave communication devices are divided into an end slave communication device and a non-end slave communication device, the last slave communication device is referred to as the end slave communication device, and the other slave communication devices except the end slave communication device are referred to as non-end slave communication devices.

The direction from the master communication device to the end slave communication device is referred to as a downstream direction, and the direction from the end slave communication device to the master communication device is referred to as an upstream direction. For a specified communication device, a communication device connected to it in the downstream direction via a communication link is referred to as a downstream device of the specified communication device, and the communication link is referred to as a downlink of the specified communication device; for a specified communication device, a communication device connected to it in the upstream direction via a communication link is referred to as an upstream device of the specified communication device, and the communication link is referred to as an uplink of the specified communication device.

The master communication device has no upstream device and no uplink, but has a downstream device and a downlink, and the downstream device thereof is a slave communication device. The end slave communication device has no downstream device and no downlink, but has an upstream device and an uplink, and the upstream device thereof can be a master communication device or a slave communication device; if there is no non-end slave communication device, the upstream device thereof is the master communication device, and if there are non-end slave communication devices, the upstream device thereof is a slave communication device. The non-end slave communication device has both an upstream device and an uplink, and a downstream device and a downlink, the upstream device thereof can be a master communication device or a slave communication device, and the downstream device thereof is a slave communication device.

For a communication link, for a communication device in the upstream direction connected thereto, the communication link is a downlink of the communication device; for a communication device in the downstream direction connected thereto, the communication link is an uplink of the communication device.

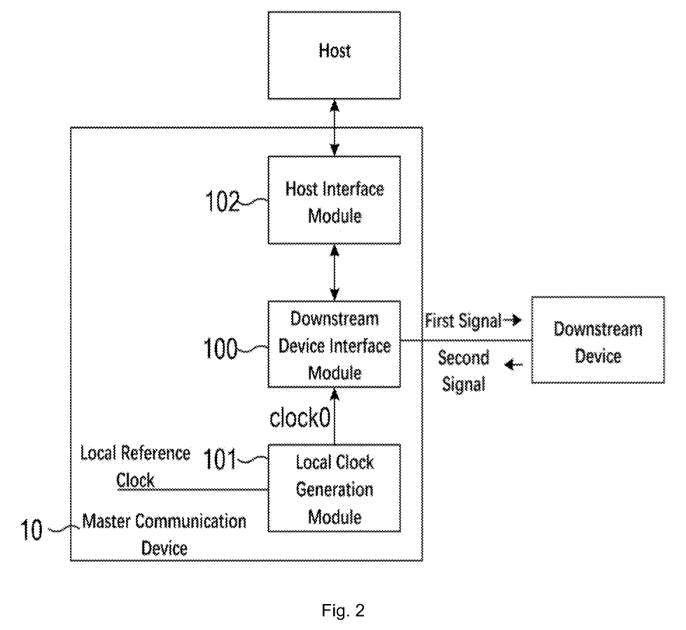

FIG. 2 shows an embodiment of a master communication device 10 in the present invention, which includes a downstream device interface module 100, a local clock generation module 101 and a host interface module 102. The downstream device interface module 100 is connected to a downstream device via a downlink, sends a first signal to the downstream device via the downlink, the downstream device sends a second signal, and the downstream device interface module 100 receives the second signal from the downstream device via the downlink. The local clock generation module 101 of the master communication device 10 generates a local clock clock0, and the clock for the downstream device interface module 100 to send the first signal is the local clock clock0. The host interface module 102 is connected to a host, and receives a data frame synchronization signal from the host. The first signal includes a synchronization frame, the downstream device interface module 100 sends the synchronization frame, the synchronization frame contains data frame synchronization signal information, and the downstream device can recover the data frame synchronization signal according to the synchronization frame. The first signal further includes a first data frame, the host interface module 102 receives data from the host, and the downstream device interface module 100 sends part or all of the data to the downstream device by including the data in the first data frame. The second signal includes a second data frame, the downstream device interface module 100 receives the second data frame, and the host interface module 102 sends part or all of the data contained in the second data frame to the host. The first signal and the second signal are transmitted on the downlink of the master communication device 10 in a time-division manner.

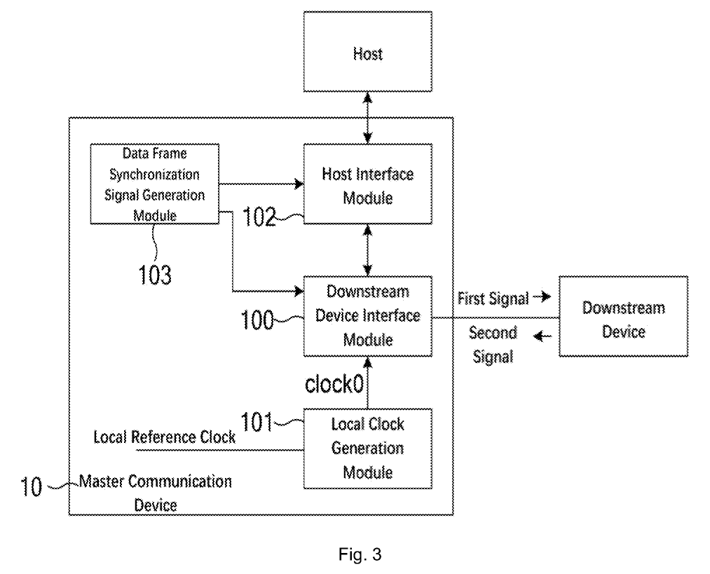

FIG. 3 shows another embodiment of the master communication device 10 in the present invention, which includes a downstream device interface module 100, a local clock generation module 101, a host interface module 102 and a data frame synchronization signal generation module 103. The downstream device interface module 100 is connected to a downstream device via a downlink, sends a first signal to the downstream device via the downlink, the downstream device sends a second signal, and the downstream device interface module 100 receives the second signal from the downstream device via the downlink. The local clock generation module 101 of the master communication device 10 generates a local clock clock0, and the clock for the downstream device interface module 100 to send the first signal is the local clock clock0. The data frame synchronization signal generation module 103 generates a data frame synchronization signal, the host interface module 102 is connected to a host, and sends the data frame synchronization signal to the host. The first signal includes a synchronization frame, the downstream device interface module 100 sends the synchronization frame, the synchronization frame contains data frame synchronization signal information, and the downstream device can recover the data frame synchronization signal according to the synchronization frame. The first signal further includes a first data frame, the host can optionally generate data based on the data frame synchronization signal, the host interface module 102 receives data from the host, and the downstream device interface module 100 sends part or all of the data to the downstream device by including the data in the first data frame. The second signal includes a second data frame, the downstream device interface module 100 receives the second data frame, and the host interface module 102 sends part or all of the data contained in the second data frame to the host. The first signal and the second signal are transmitted on the downlink of the master communication device 10 in a time-division manner. In the embodiment shown in **FIG. 3**, the master communication device 10 may also only include the downstream device interface module 100, the local clock generation module 101 and the data frame synchronization signal generation module 103, but not include the host interface module 102 and the host connected thereto. The downstream device interface module 100 is connected to a downstream device via a downlink, sends a first signal to the downstream device via the downlink, the downstream device sends a second signal, and the downstream device interface module 100 receives the second signal from the downstream device via the downlink. The local clock generation module 101 of the master communication device 10 generates a local clock clock0, and the clock for the downstream device interface module 100 to send the first signal is the local clock clock0. The data frame synchronization signal generation module 103 generates a data frame synchronization signal, the first signal includes a synchronization frame, the downstream device interface module 100 sends the synchronization frame, the synchronization frame contains data frame synchronization signal information, and the downstream device can recover the data frame synchronization signal according to the synchronization frame. The first signal further includes a first data frame, the master communication device 10 can optionally generate data based on the data frame synchronization signal, and send the generated data to the downstream device by including the data in the first data frame. The second signal includes a second data frame, the downstream device interface module 100 receives the second data frame, and the master communication device 10 can process the data included in the received second data frame. The first signal and the second signal are transmitted in a time-division manner on the downlink of the master communication device 10.

For the master communication device 10 shown in FIGS. 2 and 3, the second signal further includes a synchronization response frame. After the master communication device 10 sends the synchronization frame included in the first signal, different embodiments of the master communication device 10 may choose to send or not send any data to the downstream device within a preset time. After sending the synchronization frame included in the first signal, the master communication device 10 judges the state of its downlink according to whether the synchronization response frame is received within the preset time.

For the master communication device 10 shown in FIGS. 2 and 3, the local clock generation module 101 generates the local clock clock0 according to a local reference clock. The local reference clock generation circuit (not shown in FIGS. 2 and 3) is generally based on a quartz crystal to achieve high frequency accuracy. However, when the master communication device 10 is an integrated circuit chip, the local reference clock can also be generated by an on-chip crystal-free reference clock generation circuit of the integrated circuit chip, so as to eliminate the quartz crystal and reduce the cost and volume. The present invention does not limit the implementation method of the local clock generation module 101, and a commonly used implementation method of the local clock generation module 101 is a phase-locked loop circuit.

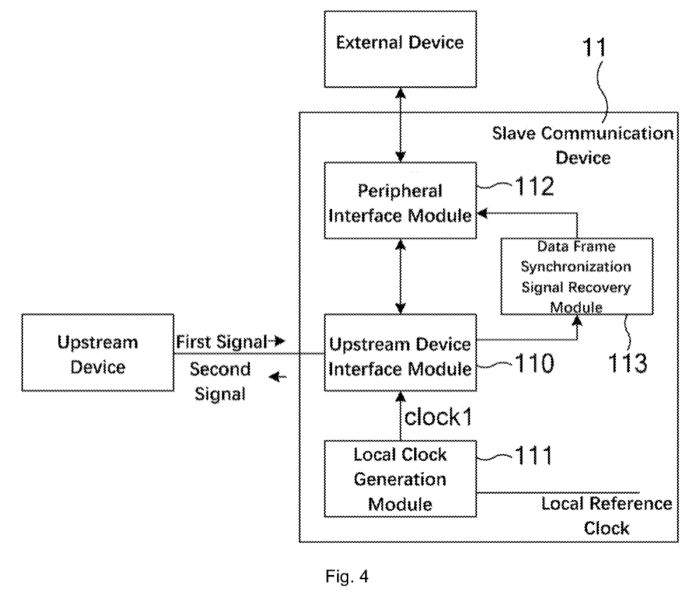

FIG. 4 shows an embodiment of a slave communication device 11 in the present invention, which is an end slave communication device and includes an upstream device interface module 110, a local clock generation module 111, a peripheral interface module 112, and a data frame synchronization signal recovery module 113.

The upstream device interface module 110 is connected to an upstream device via an uplink. The upstream device sends a first signal, the upstream device interface module 110 receives the first signal from the upstream device via the uplink, and the upstream device interface module 110 sends a second signal to the upstream device via the uplink. The local clock generation module 111 of the slave communication device 11 generates a first local clock clock1, and the clock for the upstream device interface module 110 to send the second signal is the first local clock clock1. The first signal includes a synchronization frame, and the upstream device interface module 110 receives the synchronization frame. The data frame synchronization signal recovery module 113 is connected to the upstream device interface module 110, and the data frame synchronization signal recovery module 113 recovers a data frame synchronization signal according to the received synchronization frame.

The peripheral interface module 112 is connected to an external device, and the peripheral interface module 112 can choose to communicate with the external device based on the data frame synchronization signal. The communication includes that the peripheral interface module 112 sends data to the external device, receives data from the external device, or both sends data to and receives data from the external device based on the data frame synchronization signal; the communication also includes that the peripheral interface module 112 sends the data frame synchronization signal to the external device.

The first signal further includes a first data frame. The upstream device interface module 110 receives the first data frame, and the peripheral interface module 112 sends part or all of the data contained in the first data frame to the external device. The second signal includes a second data frame. The peripheral interface module 112 receives data from the external device, and the upstream device interface module 110 sends part or all of the data to the upstream device by including the data in the second data frame. The first signal and the second signal are transmitted in a time-division manner on the uplink of the slave communication device 11.

For the slave communication device 11 shown in FIG. 4, the second signal may further include a synchronization response frame. After the upstream device interface module 110 receives the synchronization frame in the first signal, it sends the synchronization response frame to the upstream device within a preset time. In one embodiment, the slave communication device 11 sends the synchronization response frame to the upstream device earlier than any other data sent to the upstream device. For example, the preset time can be set such that the slave communication device 11 sends the synchronization response frame to the upstream device immediately after receiving the synchronization frame in the first signal, earlier than any other data sent to the upstream device.

For the slave communication device 11 shown in FIG. 4, the local clock generation module 111 generates the first local clock clock1 according to a local reference clock. The local reference clock generation circuit (not shown in FIG. 4) is generally based on a quartz crystal to achieve high frequency accuracy. However, when the slave communication device 11 is an integrated circuit chip, the local reference clock can also be generated by an on-chip crystal-free reference clock generation circuit of the integrated circuit chip, so as to eliminate the quartz crystal and reduce the cost and volume. The present invention does not limit the implementation method of the local clock generation module 111, and a commonly used implementation method of the local clock generation module 111 is a phase-locked loop circuit.

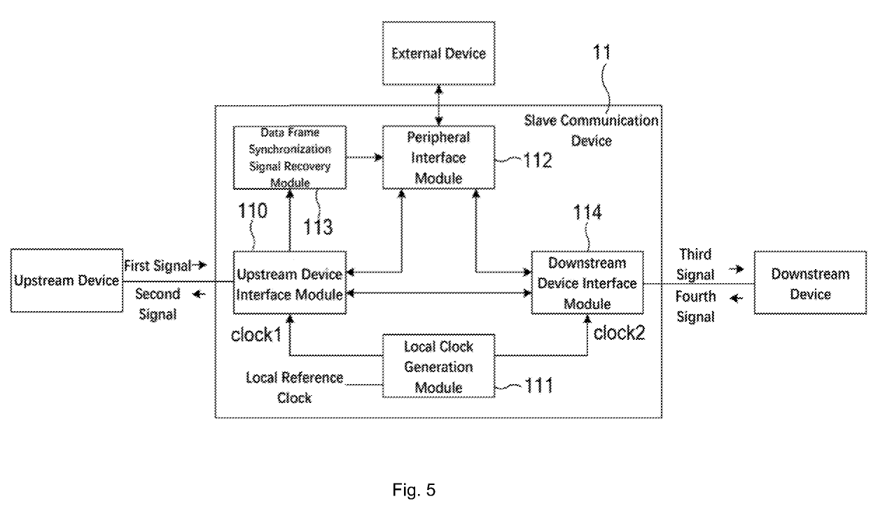

FIG. 5 shows another embodiment of the slave communication device 11 in the present invention, which is a non-end slave communication device and includes an upstream device interface module 110, a downstream device interface module 114, a local clock generation module 111, a peripheral interface module 112, and a data frame synchronization signal recovery module 113. The upstream device interface module 110 is connected to an upstream device via an uplink. The upstream device sends a first signal, the upstream device interface module 110 receives the first signal from the upstream device via the uplink, and the upstream device interface module 110 sends a second signal to the upstream device via the uplink. The first signal includes a synchronization frame, and the upstream device interface module 110 receives the synchronization frame. The data frame synchronization signal recovery module 113 is connected to the upstream device interface module 110, and the data frame synchronization signal recovery module 113 recovers a data frame synchronization signal according to the received synchronization frame.

The peripheral interface module 112 is connected to an external device, and the peripheral interface module 112 can choose to communicate with the external device based on the data frame synchronization signal. The communication includes that the peripheral interface module 112 sends data to the external device, receives data from the external device, or both sends data to and receives data from the external device based on the data frame synchronization signal; the communication also includes that the peripheral interface module 112 sends the data frame synchronization signal to the external device.

The downstream device interface module 114 is connected to a downstream device via a downlink. The downstream device interface module 114 sends a third signal to the downstream device via the downlink, and the downstream device interface module 114 receives a fourth signal from the downstream device via the downlink. The local clock generation module 111 of the slave communication device 11 generates a first local clock clock1 and a second local clock clock2. The clock for the upstream device interface module 110 to send the second signal is the first local clock clock1, and the clock for the downstream device interface module 114 to send the third signal is the second local clock clock2. The third signal includes a synchronization frame, and the downstream device interface module 114 sends the synchronization frame included in the first signal to the downstream device by including it in the third signal via the downlink, and the downstream device can recover the data frame synchronization signal according to the synchronization frame. The first signal and the second signal are transmitted in a time-division manner on the uplink of the slave communication device 11, and the third signal and the fourth signal are transmitted in a time-division manner on the downlink of the slave communication device 11.

For the slave communication device 11 shown in FIG. 5, the local clock generation module 111 generates the first local clock clock1 and the second local clock clock2 according to a local reference clock. The local reference clock generation circuit (not shown in FIG. 5) is generally based on a quartz crystal to achieve high frequency accuracy. However, when the slave communication device 11 is an integrated circuit chip, the local reference clock can also be generated by an on-chip crystal-free reference clock generation circuit of the integrated circuit chip, so as to eliminate the quartz crystal and reduce the cost and volume. The present invention does not limit the implementation method of the local clock generation module 111, and a commonly used implementation method of the local clock generation module 111 is a phase-locked loop circuit.

Simple variations and combinations of the embodiments shown in the present invention are also within the protection scope of the present invention. For example, in the embodiment shown in FIG. 5, clock1 and clock2 can be the same clock, that is, the upstream device interface module 110 and the downstream device interface module 114 can send the second signal and the third signal based on the same clock; alternatively, clock1 and clock2 can be generated by two different local clock generation modules 111 respectively, based on the same local reference clock or two different local reference clocks.

For the slave communication device 11 shown in FIG. 5, the fourth signal may include a synchronization response frame. After sending the synchronization frame included in the third signal, the slave communication device 11 judges the state of the downlink according to whether the synchronization response frame included in the fourth signal is received within a preset time.

For the slave communication device 11 shown in FIG. 5, the second signal includes a synchronization response frame. After the upstream device interface module 110 receives the synchronization frame in the first signal, it sends the synchronization response frame to the upstream device within a preset time. In one embodiment, the slave communication device 11 sends the synchronization response frame to the upstream device earlier than any other data sent to the upstream device. For example, the preset time can be set such that the slave communication device 11 sends the synchronization response frame to the upstream device immediately after receiving the synchronization frame in the first signal, earlier than any other data sent to the upstream device.

In the present invention, the time when the upstream device interface module 110 sends the synchronization response frame to the upstream device is independent of whether and when the downstream device interface module 114 receives the synchronization response frame in the fourth signal, and is also independent of whether and when the downstream device interface module 114 receives any other data in the fourth signal.

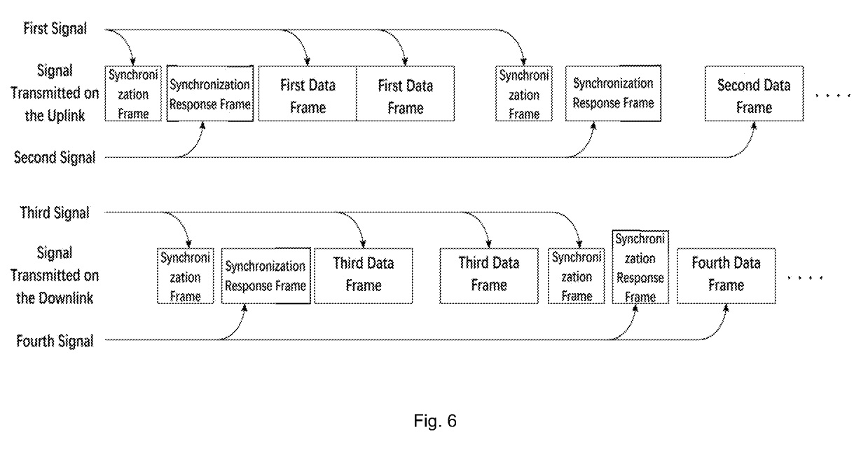

For a slave communication device 11 (shown in FIGS. 4 and 5), the first signal and the second signal are transmitted in a time-division manner on its uplink, where the first signal includes a synchronization frame and may also include a first data frame, and the second signal may include a synchronization response frame and may also include a second data frame. For a slave communication device 11 including a downstream device interface module 114 (shown in FIG. 5), the third signal and the fourth signal are transmitted in a time-division manner on its downlink, where the third signal includes a synchronization frame and may also include a third data frame, and the fourth signal may include a synchronization response frame and may also include a fourth data frame, as shown in FIG. 6.

The slave communication device 11 (shown in FIGS. 4 and 5) receives the first signal from its upstream device, i.e., receives the synchronization frame and the first data frame included in the first signal, and sends the second signal to its upstream device, i.e., sends the synchronization response frame and the second data frame included in the second signal. When a slave communication device 11 includes a downstream device interface module 114 (shown in FIG. 5), it sends the third signal to the downstream device, i.e., sends the synchronization frame and the third data frame included in the third signal, and receives the fourth signal from the downstream device, i.e., receives the synchronization response frame and the fourth data frame.

For a master communication device 10 (shown in FIGS. 2 and 3), the first signal and the second signal are transmitted in a time-division manner on its downlink, where the first signal includes a synchronization frame and may also include a first data frame, and the second signal may include a synchronization response frame and may also include a second data frame, as shown in FIG. 6.

The master communication device 10 (shown in FIGS. 2 and 3) receives the second signal from its downstream device, i.e., receives the synchronization response frame and the second data frame included in the second signal, and sends the first signal to its downstream device, i.e., sends the synchronization frame and the first data frame included in the first signal.

In the present invention, the slave communication device 11 shown in FIG. 5 forwards the received synchronization frame to the downstream device by including it in the third signal after receiving the synchronization frame included in the first signal from the upstream device, as shown in FIG. 6. In the forwarding process, the slave communication device 11 in the present invention can choose to modify the content of the synchronization frame.

Since the first signal and the second signal are transmitted in a time-division manner on the same communication link, a certain time interval should be maintained between the transmission of the first signal (i.e., the transmission of the synchronization frame and the first data frame included in the first signal) and the transmission of the second signal (i.e., the transmission of the synchronization response frame and the second data frame included in the second signal) to avoid conflicts, such as the time interval between the synchronization frame included in the first signal and the synchronization response frame included in the second signal shown in FIG. 6, or the time interval between the synchronization response frame included in the second signal and the first data frame included in the first signal shown in FIG. 6.

Since the third signal and the fourth signal are transmitted in a time-division manner on the same communication link, a certain time interval should be maintained between the transmission of the third signal (i.e., the transmission of the synchronization frame and the third data frame included in the third signal) and the transmission of the fourth signal (i.e., the transmission of the synchronization response frame and the fourth data frame included in the fourth signal) to avoid conflicts, such as the time interval between the synchronization frame included in the third signal and the synchronization response frame included in the fourth signal shown in FIG. 6, or the time interval between the synchronization response frame included in the fourth signal and the third data frame included in the third signal shown in FIG. 6.

In the present invention, multiple data frames included in the same first signal, second signal, third signal or fourth signal can be transmitted continuously or discontinuously. As shown in FIG. 6, two first data frames included in the first signal are transmitted continuously with no time interval between them, while two third data frames included in the third signal are transmitted discontinuously with a time interval between them.

For a slave communication device 11 (shown in FIGS. 4 and 5), it can choose to send a synchronization response frame within a preset time after receiving the synchronization frame included in the first signal. As shown in FIG. 6, the slave communication device 11 sends the synchronization response frame after receiving the synchronization frame included in the first signal, and the sending time of the synchronization response frame is within the preset time and earlier than any other data sent to the upstream device. The time when the slave communication device 11 sends the synchronization response frame is independent of whether and when the downstream device interface module 114 receives the synchronization response frame in the fourth signal, and is also independent of whether and when the downstream device interface module 114 receives any other data in the fourth signal.

For a master communication device 10 (shown in FIGS. 2 and 3), after sending the synchronization frame included in the first signal, different embodiments of the master communication device 10 may choose to send or not send any data to the downstream device within a preset time. As shown in FIG. 6, the master communication device 10 sends the first signal, and the slave communication device 11 (shown in FIGS. 4 and 5) receives the first signal and sends the second signal. The master communication device 10 does not send any data to the downstream device within a preset time after sending the synchronization frame included in the first signal, i.e., does not send the first data frame included in the first signal within the preset time. The slave communication device 11 sends the synchronization response frame within the preset time after receiving the synchronization frame included in the first signal, and the sending time of the synchronization response frame is earlier than the time when the master communication device 10 sends the first data frame included in the first signal.

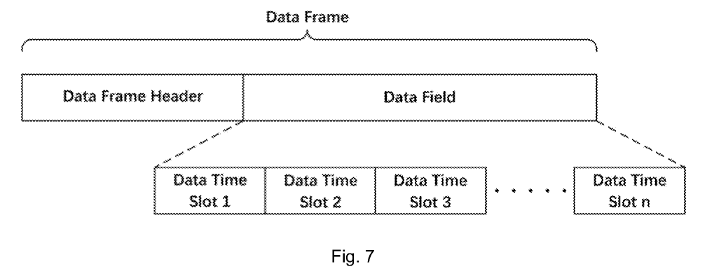

In the present invention, the first data frame, the second data frame, the third data frame and the fourth data frame are collectively referred to as data frames. The present invention does not limit the structure and processing method of the data frame. As a structure and processing method of the data frame in the present invention, as shown in FIG. 7, the data frame includes a data frame header and a data field. Each communication device uses the data frame header to identify the data frame, and the data field includes multiple data time slots for carrying data payloads. Each communication device can add or delete data time slots, and can also initialize, replace or clear the data payloads in the data time slots. Each communication device can be allocated one or more data time slots. When a communication device needs to send data, it can put the data payload into the corresponding data time slot in the data frame, or add a data time slot to the data frame and put the data payload into the data time slot; when a communication device needs to receive data, it can read the data payload from the corresponding data time slot, or read the data payload from the corresponding data time slot and then delete the data time slot from the data frame; when a communication device needs to send and receive data, it can read the data payload from the corresponding data time slot and replace the data payload in the data time slot.

The slave communication device 11 shown in FIGS. 4 and 5 can receive the first data frame and send part or all of the data contained in the first data frame to the external device.

The slave communication device 11 shown in FIGS. 4 and 5 can receive data from the external device and send part or all of the data to the upstream device by including the data in the second data frame.

The slave communication device 11 shown in FIG. 5 can receive the first data frame and send part or all of the data contained in the first data frame to the downstream device by including the data in the third data frame.

The slave communication device 11 shown in FIG. 5 can receive data from the external device and send part or all of the data to the downstream device by including the data in the third data frame.

The slave communication device 11 shown in FIG. 5 can receive the first data frame and also receive data from the external device, and send part or all of the data contained in the first data frame and part or all of the data received from the external device to the downstream device by including the data in the third data frame.

The slave communication device 11 shown in FIG. 5 can receive the fourth data frame and send part or all of the data contained in the fourth data frame to the external device.

The slave communication device 11 shown in FIG. 5 can receive the fourth data frame and send part or all of the data contained in the fourth data frame to the upstream device by including the data in the second data frame.

The slave communication device 11 shown in FIG. 5 can receive the fourth data frame and also receive data from the external device, and send part or all of the data contained in the fourth data frame and part or all of the data received from the external device to the upstream device by including the data in the second data frame.

The present invention does not limit the encoding method of the first signal, the second signal, the third signal and the fourth signal. In one embodiment of the present invention, the first signal, the second signal, the third signal and the fourth signal can adopt an encoding method with built-in clock information, such as 8b/10b, 4b/5b, Manchester encoding, etc.

For a slave communication device 11 (shown in FIGS. 4 and 5), the clock for the upstream device to send the first signal is a local clock generated by the upstream device, and the clock for the slave communication device 11 to send the second signal is the first local clock clock1 generated by the slave communication device 11. The local clock generated by the upstream device and the first local clock clock1 generated by the slave communication device 11 are not synchronous, i.e., the upstream device and the slave communication device 11 use their respective local reference clocks. Therefore, the local clock generated by the upstream device and the first local clock clock1 generated by the slave communication device 11 are asynchronous clocks, and the first local clock clock1 generated by the slave communication device 11 is not locked to the transmission rate of the first signal sent by the upstream device. For a slave communication device 11 (shown in FIG. 5), the clock for the downstream device to send the fourth signal is a local clock generated by the downstream device, and the clock for the slave communication device 11 to send the third signal is the second local clock clock2 generated by the slave communication device 11. The local clock generated by the downstream device and the second local clock clock2 generated by the slave communication device 11 are not synchronous, i.e., the downstream device and the slave communication device 11 use their respective local reference clocks. Therefore, the local clock generated by the downstream device and the second local clock clock2 generated by the slave communication device 11 are asynchronous clocks, and the second local clock clock2 generated by the slave communication device 11 is not locked to the transmission rate of the fourth signal sent by the downstream device.

For a master communication device 10 (shown in FIGS. 2 and 3), the clock for the downstream device to send the second signal is a local clock generated by the downstream device, and the clock for the master communication device 10 to send the first signal is the local clock clock0 generated by the master communication device 10. The local clock generated by the downstream device and the local clock clock0 generated by the master communication device 10 are not synchronous, i.e., the downstream device and the master communication device 10 use their respective local reference clocks. Therefore, the local clock generated by the downstream device and the local clock clock0 generated by the master communication device 10 are asynchronous clocks, and the local clock clock0 generated by the master communication device 10 is not locked to the transmission rate of the second signal sent by the downstream device.

In the present invention, a clock and data recovery (CDR) circuit can be used to receive the encoded first signal or fourth signal. A commonly used clock and data recovery circuit in the industry is an oversampling receiving circuit. The present invention does not specify the selection of the clock and data recovery circuit, and any applicable clock and data recovery circuit can be used in the present invention to receive the first signal or fourth signal.

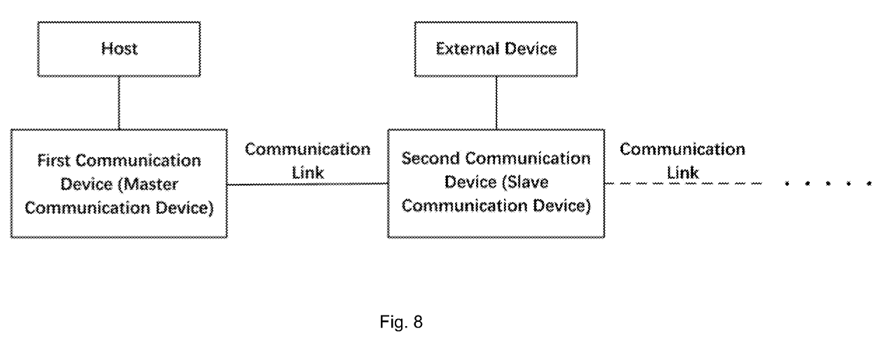

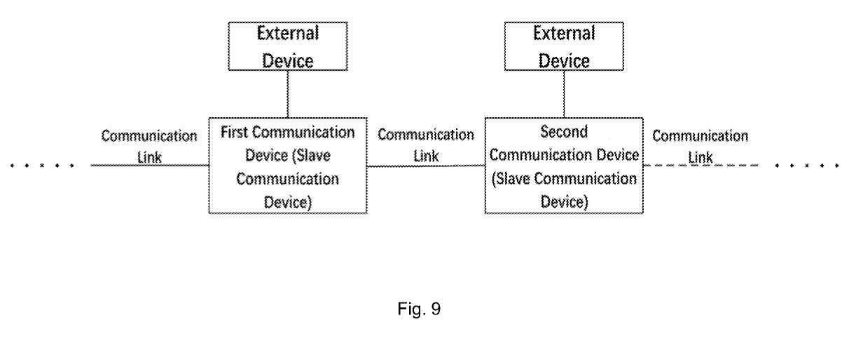

FIGS. 8 and 9 show an embodiment of the half-duplex data communication system of the present invention (master-slave structure). The half-duplex data communication system includes a first communication device and a second communication device, which are connected via a communication link. The first communication device is an upstream device of the second communication device, and the second communication device is a downstream device of the first communication device. The first communication device can be a master communication device (shown in FIG. 8) or a slave communication device (shown in FIG. 9), and the second communication device is a slave communication device. If the second communication device is a non-end slave communication device, it is also connected to its downstream device via its downlink.

The first communication device sends the first signal to the second communication device via its downlink, and receives the second signal from the second communication device via its downlink. The second communication device sends the second signal to the first communication device via its uplink, and receives the first signal from the first communication device via its uplink. The first signal and the second signal are transmitted in a time-division manner on the downlink of the first communication device. The first signal includes a synchronization frame and may also include a first data frame, and the second signal may include a synchronization response frame and may also include a second data frame.

If the second communication device is a non-end slave communication device, it sends the third signal to its downstream device via its downlink, and receives the fourth signal from its downstream device via its downlink. The third signal and the fourth signal are transmitted in a time-division manner on the downlink of the second communication device. The third signal includes a synchronization frame and may also include a third data frame, and the fourth signal may include a synchronization response frame and may also include a fourth data frame.

In the embodiment shown in FIG. 8, the first communication device is a master communication device, which is the same as the master communication device 10 shown in FIGS. 2 and 3 and the relevant descriptions above, and will not be repeated here.

In the embodiment shown in FIG. 9, the first communication device is a slave communication device, which is the same as the slave communication device 11 shown in FIGS. 4 and 5 and the relevant descriptions above, and will not be repeated here.

In the present invention, the slave communication device 11 receives the synchronization frame from its upstream device, where the synchronization frame contains data frame synchronization signal information, and the slave communication device 11 recovers the data frame synchronization signal according to the synchronization frame.

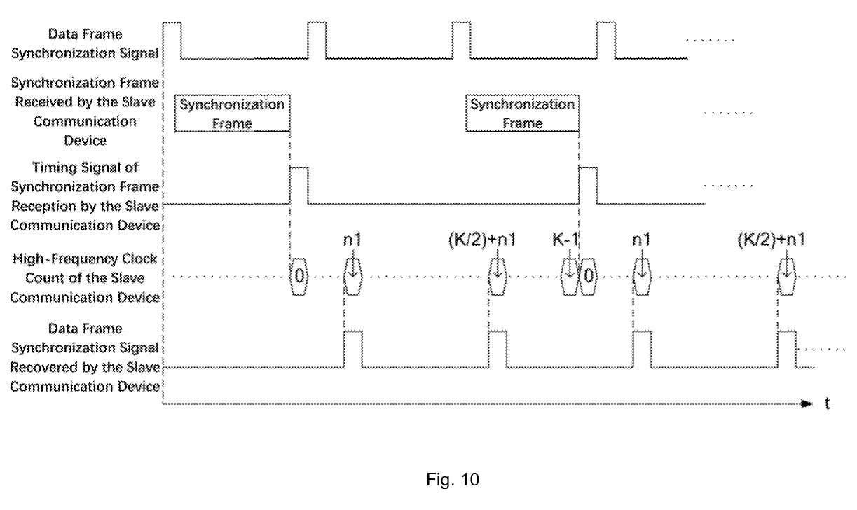

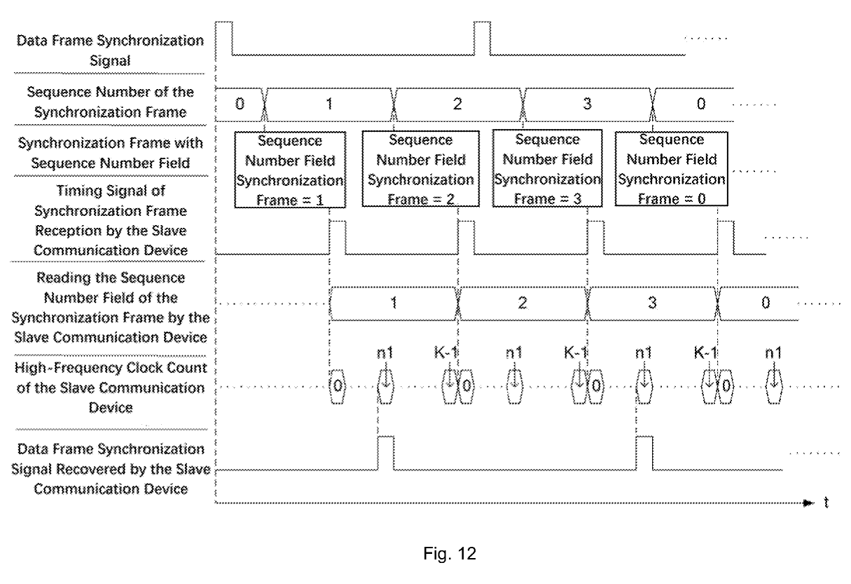

In the present invention, the synchronization frame is initially sent by the master communication device 10 to its downstream device (the downstream device of the master communication device 10 is the slave communication device 11), and the slave communication device 11 receives the synchronization frame from its upstream device (the upstream device of the slave communication device 11 is the master communication device 10 or the slave communication device 11). In the embodiment of the master communication device 10 shown in FIG. 2, the host interface module 102 is connected to a host, and the host interface module 102 receives the data frame synchronization signal shown in FIGS. 10 and 12 from the host. In another embodiment of the master communication device 10 shown in FIG. 3, the master communication device 10 includes a data frame synchronization signal generation module 103, which generates the data frame synchronization signal shown in FIGS. 10 and 12.

In the present invention, the synchronization frame is initially sent by the master communication device 10, and the slave communication device 11 receives and forwards the synchronization frame. The synchronization frame contains data frame synchronization signal information, including that the ratio of the frame frequency of the synchronization frame to the frequency of the data frame synchronization signal is M/N, where M and N are both positive integers, i.e., the frame frequency of the synchronization frame is locked to the frequency of the data frame synchronization signal in the ratio of M/N. The data frame synchronization signal recovery module 113 (included in the slave communication device 11) recovers the data frame synchronization signal according to the timing signal of the received synchronization frame. Several values of M and N are given as follows: when M=1 and N=1, the frame frequency of the synchronization frame is the same as the frequency of the data frame synchronization signal, i.e., one synchronization frame is sent for each pulse of the data frame synchronization signal; when M=1 and N=2, the frame frequency of the synchronization frame is half of the frequency of the data frame synchronization signal, i.e., one synchronization frame is sent for every two pulses of the data frame synchronization signal; when M=2 and N=1, the frame frequency of the synchronization frame is twice the frequency of the data frame synchronization signal, i.e., two synchronization frames are sent for each pulse of the data frame synchronization signal.

FIG. 10 shows an embodiment, which provides an implementation method for recovering the data frame synchronization signal according to the synchronization frame. The data frame synchronization signal shown in FIG. 10 is the data frame synchronization signal used by the master communication device 10 to send the synchronization frame, and the ratio of the frame frequency of the synchronization frame to the frequency of the data frame synchronization signal is M/N. In this example, M=1 and N=2, i.e., the frame frequency of the synchronization frame is half of the frequency of the data frame synchronization signal. The slave communication device 11 recovers the data frame synchronization signal (denoted as the data frame synchronization signal recovered by the slave communication device in FIG. 10) according to the timing signal of the received synchronization frame (the timing signal of the synchronization frame generated after receiving the synchronization frame). In one embodiment, after receiving the synchronization frame, the slave communication device 11 generates a timing signal of the synchronization frame, and can send the timing signal of the synchronization frame to a phase-locked loop circuit (included in the data frame synchronization signal recovery module 113) to generate a high-frequency clock. If the frequency of the high-frequency clock is K times the frequency of the timing signal of the synchronization frame, the slave communication device 11 counts the high-frequency clock. In this embodiment, the count value is 0 when the timing signal of the synchronization frame is at a high level, and the count value cycles from 0 to the maximum value K-1. The slave communication device 11 generates a high-level pulse of the data frame synchronization signal when counting to n1 and (K/2)+n1 respectively, thereby recovering the data frame synchronization signal (denoted as the data frame synchronization signal recovered by the slave communication device in FIG. 10). The frequency of the recovered data frame synchronization signal is twice the frame frequency of the synchronization frame, which is equal to the frequency of the data frame synchronization signal used by the master communication device 10 to send the synchronization frame. Meanwhile, due to the existence of the high-frequency clock count values from 0 to K-1, the recovered data frame synchronization signal can be output at a preset count value (phase) of the high-frequency clock, i.e., the delay of the recovered data frame synchronization signal relative to the timing signal of the synchronization frame can be selected. In other embodiments, the frequency of the recovered data frame synchronization signal can also be different from the frequency of the data frame synchronization signal used by the master communication device 10 to send the synchronization frame. For example, if the slave communication device 11 only generates a high-level pulse of the data frame synchronization signal when counting to n1, the frequency of the recovered data frame synchronization signal is equal to the frame frequency of the synchronization frame, which is half of the frequency of the data frame synchronization signal used by the master communication device 10 to send the synchronization frame; if the slave communication device 11 generates a high-level pulse of the data frame synchronization signal when counting to n1, (K/4)+n1, (K/2)+n1 and (3K/4)+n1 respectively, the frequency of the recovered data frame synchronization signal is twice the frequency of the data frame synchronization signal used by the master communication device 10 to send the synchronization frame.

In the present invention, the synchronization frame may include a sequence number field. The synchronization frame contains data frame synchronization signal information, including that the ratio of the frame frequency of the synchronization frame to the frequency of the data frame synchronization signal is M/N, where M and N are both positive integers, i.e., the frame frequency of the synchronization frame is locked to the frequency of the data frame synchronization signal in the ratio of M/N. The synchronization frame includes a sequence number field containing the sequence number of the synchronization frame, and the data frame synchronization signal recovery module 113 (included in the slave communication device 11) recovers the data frame synchronization signal according to the sequence number field of the synchronization frame and the timing signal of the received synchronization frame.

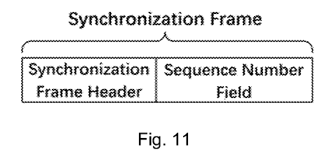

FIG. 11 shows an embodiment, where the synchronization frame includes a synchronization frame header and a sequence number field. The slave communication device 11 uses the synchronization frame header to identify the synchronization frame, and the sequence number field contains the sequence number of the synchronization frame, i.e., the count value of the synchronization frame.

FIG. 12 shows an embodiment, which provides another implementation method for recovering the data frame synchronization signal according to the synchronization frame. The data frame synchronization signal shown in FIG. 12 is the data frame synchronization signal used by the master communication device 10 to send the synchronization frame, and the ratio of the frame frequency of the synchronization frame to the frequency of the data frame synchronization signal is M/N. In this example, M=2 and N=1, i.e., the frame frequency of the synchronization frame is twice the frequency of the data frame synchronization signal, i.e., two synchronization frames are sent for each pulse of the data frame synchronization signal, and the count value of the sequence number of the synchronization frame contained in the sequence number field cycles from 0 to 3. The slave communication device 11 recovers the data frame synchronization signal (denoted as the data frame synchronization signal recovered by the slave communication device in FIG. 12) according to the sequence number field of the synchronization frame and the timing signal of the received synchronization frame (the timing signal of the synchronization frame generated after receiving the synchronization frame).

In one embodiment, after receiving the synchronization frame, the slave communication device 11 generates a timing signal of the synchronization frame, and can send the timing signal of the synchronization frame to a phase-locked loop circuit (included in the data frame synchronization signal recovery module 113) to generate a high-frequency clock. If the frequency of the high-frequency clock is K times the frequency of the timing signal of the synchronization frame, the slave communication device 11 counts the high-frequency clock. In this embodiment, the count value is 0 when the timing signal of the synchronization frame is at a high level, and the count value cycles from 0 to the maximum value K-1. The slave communication device 11 generates a high-level pulse of the data frame synchronization signal when counting to n1 and the sequence number of the synchronization frame is an odd number, thereby recovering the data frame synchronization signal (denoted as the data frame synchronization signal recovered by the slave communication device in FIG. 12). The frequency of the recovered data frame synchronization signal is half of the frame frequency of the synchronization frame, which is equal to the frequency of the data frame synchronization signal used by the master communication device 10 to send the synchronization frame. Meanwhile, due to the existence of the high-frequency clock count values from 0 to K-1, the recovered data frame synchronization signal can be output at a preset count value (phase) of the high-frequency clock, i.e., the delay of the recovered data frame synchronization signal relative to the timing signal of the synchronization frame can be selected. Furthermore, due to the existence of the sequence number of the synchronization frame, the data frame synchronization signal can be output only at a preset sequence number of the synchronization frame and a preset count value (phase) of the high-frequency clock. In other embodiments, the slave communication device 11 can choose to generate a high-level pulse of the data frame synchronization signal at a different count value of the high-frequency clock or a different sequence number of the synchronization frame from those shown in FIG. 12 to recover the data frame synchronization signal. For example, the slave communication device 11 can generate a high-level pulse of the data frame synchronization signal when counting to n1 and the sequence number of the synchronization frame is 2 (this case is not shown in FIG. 12). In this case, the frequency of the recovered data frame synchronization signal is a quarter of the frame frequency of the synchronization frame, which is half of the frequency of the data frame synchronization signal used by the master communication device 10 to send the synchronization frame.

In the present invention, the synchronization frame may include a phase field containing phase relationship information between the synchronization frame and the data frame synchronization signal, and the data frame synchronization signal recovery module 113 (included in the slave communication device 11) recovers the data frame synchronization signal according to the phase field.

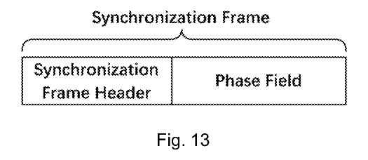

As shown in FIG. 13, the synchronization frame includes a synchronization frame header and a phase field. The slave communication device 11 uses the synchronization frame header to identify the synchronization frame, and the phase field contains phase relationship information between the synchronization frame and the data frame synchronization signal.

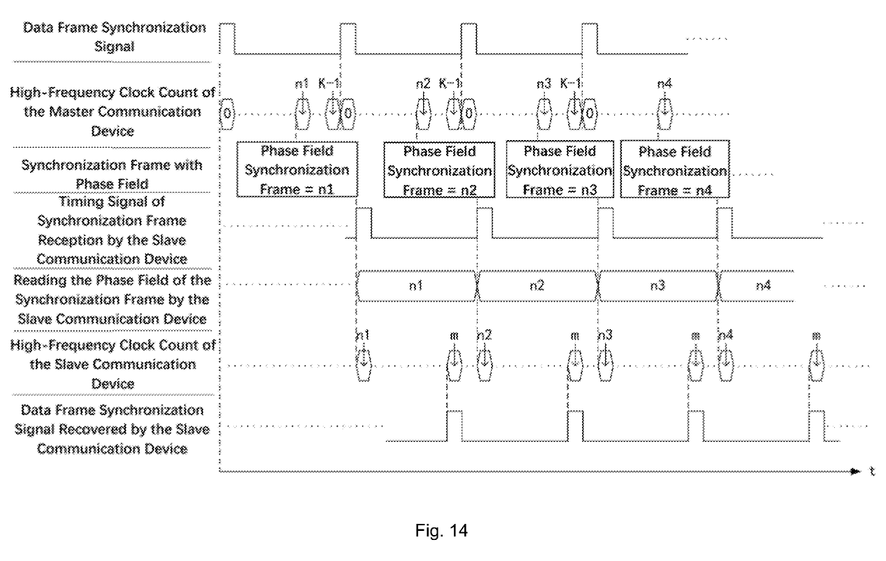

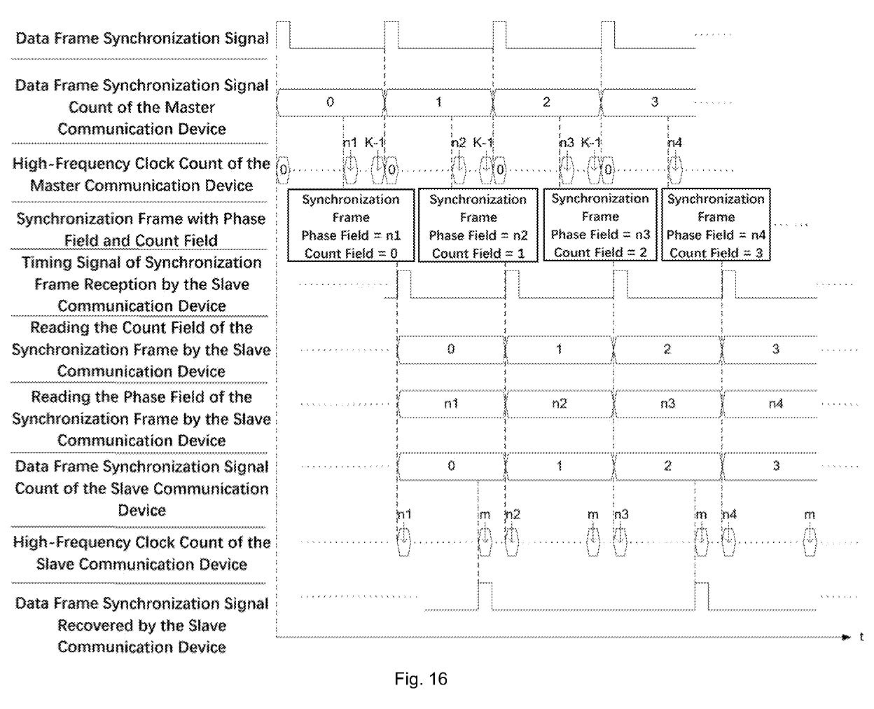

In the present invention, the synchronization frame is initially sent by the master communication device 10 to its downstream device (the downstream device of the master communication device 10 is the slave communication device 11), and the slave communication device 11 receives the synchronization frame from its upstream device (the upstream device of the slave communication device 11 is the master communication device 10 or the slave communication device 11). In the embodiment of the master communication device 10 shown in FIG. 2, the host interface module 102 is connected to a host, and the host interface module 102 receives the data frame synchronization signal shown in FIGS. 14 and 16 from the host. In another embodiment of the master communication device 10 shown in FIG. 3, the master communication device 10 includes a data frame synchronization signal generation module 103, which generates the data frame synchronization signal shown in FIGS. 14 and 16.

FIG. 14 shows an embodiment, which provides an implementation method for recovering the data frame synchronization signal according to the synchronization frame. The data frame synchronization signal shown in FIG. 14 is the data frame synchronization signal in the master communication device 10, which can be sent to a phase-locked loop circuit (included in the master communication device 10) to generate a high-frequency clock. If the frequency of the high-frequency clock is K times the frequency of the timing signal of the synchronization frame, the master communication device 10 counts the high-frequency clock cyclically from 0 to K-1. The master communication device 10 sends the synchronization frame, and the frame frequency of the synchronization frame can be independent of the frequency of the data frame synchronization signal, i.e., the frame frequency of the synchronization frame is not required to have a definite proportional relationship with the frequency of the data frame synchronization signal (the frame frequency of the synchronization frame is not required to be locked to the frequency of the data frame synchronization signal in a definite proportional relationship). Of course, the frame frequency of the synchronization frame can also have a definite proportional relationship with the frequency of the data frame synchronization signal, i.e., the frame frequency of the synchronization frame is locked to the frequency of the data frame synchronization signal in a definite proportional relationship. This embodiment does not limit how the master communication device 10 determines the frame frequency of the synchronization frame. In the embodiment shown in FIG. 14, the frame frequency of the synchronization frame is independent of the frequency of the data frame synchronization signal. Furthermore, the interval between two adjacent synchronization frames can be fixed or variable, and in the embodiment shown in FIG. 14, the interval between two adjacent synchronization frames is variable. When the master communication device 10 sends the synchronization frame, the phase field of the synchronization frame can be the count value of the high-frequency clock of the master communication device 10 at the moment of sending the synchronization frame, so that the phase field contains phase relationship information between the synchronization frame and the data frame synchronization signal.

The slave communication device 11 recovers the data frame synchronization signal according to the phase field. In one embodiment, after receiving the synchronization frame, the slave communication device 11 generates a timing signal of the synchronization frame and reads the phase field of the synchronization frame, and the slave communication device 11 can send the timing signal of the synchronization frame and the read phase field of the synchronization frame to the data frame synchronization signal recovery module 113, which recovers the data frame synchronization signal. The present invention does not limit the implementation method of the data frame synchronization signal recovery module 113. In one embodiment, the data frame synchronization signal recovery module 113 may include a high-frequency clock generation circuit and a high-frequency clock counter, and the counting range of the high-frequency clock counter may cycle from 0 to K-1. As shown in FIG. 14, the counting range of the high-frequency clock in the slave communication device 11 can be selected to be the same as that in the master communication device 10.

At the moment of receiving the synchronization frame, i.e., when the timing signal of the synchronization frame is a high-level pulse, the data frame synchronization signal recovery module 113 compares the difference between the phase field read from the synchronization frame and the count value of the high-frequency clock of the data frame synchronization signal recovery module 113. This difference can be used as a phase error signal to adjust the frequency and phase of the high-frequency clock generated by the high-frequency clock generation circuit included in the data frame synchronization signal recovery module 113 to minimize the phase error, thereby recovering a high-frequency clock and a high-frequency clock count value that are frequency and phase locked to the high-frequency clock in the master communication device 10 in the data frame synchronization signal recovery module 113.

As shown in FIG. 14, the values of the phase field of the synchronization frame are n1, n2, n3 and n4, and the count values of the high-frequency clock recovered by the slave communication device 11 at the moment when the timing signal of the synchronization frame is a high-level pulse are also n1, n2, n3 and n4. In this example, the phase error has been reduced to 0. In the embodiment shown in FIG. 14, the slave communication device 11 generates a high-level pulse of the data frame synchronization signal when counting to m, thereby recovering the data frame synchronization signal (denoted as the data frame synchronization signal recovered by the slave communication device in FIG. 14). The slave communication device 11 can choose to output the recovered data frame synchronization signal at a preset count value (phase) of the high-frequency clock. Since the count value of the high-frequency clock recovered in the data frame synchronization signal recovery module 113 is locked to the count value of the high-frequency clock in the master communication device 10, the delay of the recovered data frame synchronization signal relative to the data frame synchronization signal in the master communication device 10 can be preset.

In the present invention, the synchronization frame may include a phase field and a counting field, where the phase field contains phase relationship information between the synchronization frame and the data frame synchronization signal, and the counting field contains the count value of the data frame synchronization signal. The data frame synchronization signal recovery module 113 recovers the data frame synchronization signal according to the phase field and the counting field.

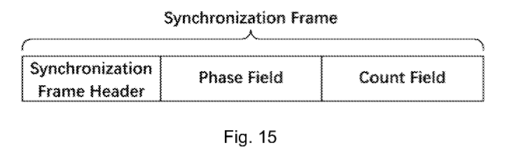

As shown in FIG. 15, the synchronization frame includes a synchronization frame header, a phase field and a counting field. The slave communication device 11 uses the synchronization frame header to identify the synchronization frame, the phase field contains phase relationship information between the synchronization frame and the data frame synchronization signal, and the counting field contains the count value of the data frame synchronization signal.

FIG. 16 shows an embodiment, which provides an implementation method for recovering the data frame synchronization signal according to the synchronization frame. The data frame synchronization signal shown in FIG. 16 is the data frame synchronization signal in the master communication device 10, which can be sent to a phase-locked loop circuit (included in the master communication device 10) to generate a high-frequency clock. If the frequency of the high-frequency clock is K times the frequency of the timing signal of the synchronization frame, the master communication device 10 counts the high-frequency clock cyclically from 0 to K-1. The master communication device 10 also includes a data frame synchronization signal counter for counting the data frame synchronization signal. In the embodiment shown in FIG. 16, the count value of the data frame synchronization signal cycles from 0 to 3. The master communication device 10 sends the synchronization frame, and the frame frequency of the synchronization frame can be independent of the frequency of the data frame synchronization signal, i.e., the frame frequency of the synchronization frame is not required to have a definite proportional relationship with the frequency of the data frame synchronization signal (the frame frequency of the synchronization frame is not required to be locked to the frequency of the data frame synchronization signal in a definite proportional relationship). Of course, the frame frequency of the synchronization frame can also have a definite proportional relationship with the frequency of the data frame synchronization signal, i.e., the frame frequency of the synchronization frame is locked to the frequency of the data frame synchronization signal in a definite proportional relationship. This embodiment does not limit how the master communication device 10 determines the frame frequency of the synchronization frame. In the embodiment shown in FIG. 16, the frame frequency of the synchronization frame is independent of the frequency of the data frame synchronization signal. Furthermore, the interval between two adjacent synchronization frames can be fixed or variable, and in the embodiment shown in FIG. 16, the interval between two adjacent synchronization frames is variable. When the master communication device 10 sends the synchronization frame, the phase field of the synchronization frame can be the count value of the high-frequency clock of the master communication device 10 at the moment of sending the synchronization frame, so that the phase field contains phase relationship information between the synchronization frame and the data frame synchronization signal, and the counting field of the synchronization frame can be the count value of the data frame synchronization signal of the master communication device 10 at the moment of sending the synchronization frame.

The slave communication device 11 recovers the data frame synchronization signal according to the phase field and the counting field. In one embodiment, after receiving the synchronization frame, the slave communication device 11 generates a timing signal of the synchronization frame and reads the phase field and the counting field of the synchronization frame, and the slave communication device 11 can send the timing signal of the synchronization frame and the read phase field and counting field of the synchronization frame to the data frame synchronization signal recovery module 113, which recovers the data frame synchronization signal. The present invention does not limit the implementation method of the data frame synchronization signal recovery module 113. In one embodiment, the data frame synchronization signal recovery module 113 may include a high-frequency clock generation circuit, a high-frequency clock counter and a data frame synchronization signal counter. The counting range of the high-frequency clock counter may cycle from 0 to K-1, and the counting range of the data frame synchronization signal counter may cycle from 0 to 3. When the count value of the high-frequency clock counter jumps from K-1 to 0, the data frame synchronization signal counter is incremented by 1. As shown in FIG. 16, the counting range of the high-frequency clock and the counting range of the data frame synchronization signal in the slave communication device 11 can be selected to be the same as those in the master communication device 10.

At the moment of receiving the synchronization frame, i.e., when the timing signal of the synchronization frame is a high-level pulse, the data frame synchronization signal recovery module 113 compares the difference between the phase field and counting field read from the synchronization frame and the count value of the high-frequency clock and the count value of the data frame synchronization signal of the data frame synchronization signal recovery module 113. This difference can be used as a phase error signal to adjust the frequency and phase of the high-frequency clock generated by the high-frequency clock generation circuit included in the data frame synchronization signal recovery module 113 to minimize the phase error, thereby recovering a high-frequency clock, a high-frequency clock count value and a data frame synchronization signal count value that are frequency and phase locked to the high-frequency clock in the master communication device 10 in the data frame synchronization signal recovery module 113.

As shown in FIG. 16, the values of the phase field/counting field of the synchronization frame are n1/0, n2/1, n3/2 and n4/3, and the count values of the high-frequency clock/data frame synchronization signal recovered by the slave communication device 11 at the moment when the timing signal of the synchronization frame is a high-level pulse are also n1/0, n2/1, n3/2 and n4/3. In this example, the phase error has been reduced to 0. In the embodiment shown in FIG. 16, the slave communication device 11 generates a high-level pulse of the data frame synchronization signal when the high-frequency clock counts to m and the count value of the data frame synchronization signal is an even number, thereby recovering the data frame synchronization signal (denoted as the data frame synchronization signal recovered by the slave communication device in FIG. 16). In this example, the frequency of the recovered data frame synchronization signal is half of the frequency of the data frame synchronization signal in the master communication device 10. The slave communication device 11 can choose to output the recovered data frame synchronization signal at a preset count value (phase) of the high-frequency clock and a preset count value of the data frame synchronization signal. Since the count value of the high-frequency clock and the count value of the data frame synchronization signal recovered in the data frame synchronization signal recovery module 113 are locked to the count value of the high-frequency clock and the count value of the data frame synchronization signal in the master communication device 10, the delay of the recovered data frame synchronization signal relative to the data frame synchronization signal in the master communication device 10 can be preset, and the frequency can also be different from the frequency of the data frame synchronization signal in the master communication device 10.

The above descriptions are only the preferred embodiments of the present invention, but the protection scope of the present invention is not limited thereto. Any person skilled in the art who makes changes, modifications, substitutions and variations to the above embodiments within the technical scope disclosed by the present invention shall all fall within the protection scope of the present invention.

What is claimed is:

1. A slave communication device, comprising an upstream device interface module, a data frame synchronization signal recovery module, a local clock generation module and a peripheral interface module, characterized in that:
the upstream device interface module is connected to an upstream device via an uplink, the upstream device sends a first signal, the upstream device interface module receives the first signal from the upstream device via the uplink, and the upstream device interface module sends a second signal to the upstream device via the uplink;
the first signal includes a synchronization frame, and the upstream device interface module receives the synchronization frame;
the data frame synchronization signal recovery module is connected to the upstream device interface module, and the data frame synchronization signal recovery module recovers a data frame synchronization signal according to the received synchronization frame;
the local clock generation module generates a first local clock, and the clock for the upstream device interface module to send the second signal is the first local clock;
the first signal and the second signal are transmitted on the uplink in a time-division manner.

2. The slave communication device according to claim 1, characterized in that:
the slave communication device further comprises a downstream device interface module;
the downstream device interface module is connected to a downstream device via a downlink, the downstream device interface module sends a third signal to the downstream device via the downlink, and the downstream device interface module receives a fourth signal from the downstream device via the downlink;
the slave communication device sends the received synchronization frame to the downstream device by including the synchronization frame in the third signal via the downlink;
the local clock generation module further generates a second local clock, and the clock for the downstream device interface module to send the third signal is the second local clock;
the third signal and the fourth signal are transmitted on the downlink in a time-division manner.

3. The slave communication device according to claim 1, characterized in that:
the peripheral interface module is connected to an external device, and the peripheral interface module communicates with the external device based on the data frame synchronization signal.

4. The slave communication device according to claim 3, characterized in that:
the peripheral interface module communicating with the external device based on the data frame synchronization signal includes that the peripheral interface module sends data to the external device, or receives data from the external device, or sends data to the external device and receives data from the external device based on the data frame synchronization signal.

5. The slave communication device according to claim 3, characterized in that:
the peripheral interface module communicating with the external device based on the data frame synchronization signal includes that the peripheral interface module sends the data frame synchronization signal to the external device.

6. The slave communication device according to claim 1, characterized in that:
the slave communication device is an integrated circuit chip, the local clock generation module generates the first local clock according to a local reference clock, and the local reference clock is generated by an on-chip crystal-free reference clock generation circuit of the integrated circuit chip.

7. The slave communication device according to claim 2, characterized in that:
the slave communication device is an integrated circuit chip, the local clock generation module generates the first local clock and the second local clock according to a local reference clock, and the local reference clock is generated by an on-chip crystal-free reference clock generation circuit of the integrated circuit chip.

8. The slave communication device according to claim 1, characterized in that:
the ratio of the frame frequency of the synchronization frame to the frequency of the data frame synchronization signal is M/N, where M and N are both positive integers;
the data frame synchronization signal recovery module recovers the data frame synchronization signal according to the timing signal of the received synchronization frame.

9. The slave communication device according to claim 8, characterized in that:
the synchronization frame includes a sequence number field, the sequence number field contains a sequence number of the synchronization frame, and the data frame synchronization signal recovery module recovers the data frame synchronization signal according to the sequence number field and the timing signal of the received synchronization frame.

10. The slave communication device according to claim 1, characterized in that:
the synchronization frame includes a phase field, the phase field contains phase relationship information between the synchronization frame and the data frame synchronization signal;
the data frame synchronization signal recovery module recovers the data frame synchronization signal according to the phase field.

11. The slave communication device according to claim 1, characterized in that:
the synchronization frame includes a phase field and a counting field, the phase field contains phase relationship information between the synchronization frame and the data frame synchronization signal, and the counting field contains a count value of the data frame synchronization signal;
the data frame synchronization signal recovery module recovers the data frame synchronization signal according to the phase field and the counting field.

12. The slave communication device according to claim 11, characterized in that:
the frame frequency of the synchronization frame is independent of the frequency of the data frame synchronization signal.

13. The slave communication device according to claim 3, characterized in that:
the first signal further includes a first data frame, and the slave communication device receives the first data frame and sends part or all of the data contained in the first data frame to the external device.

14. The slave communication device according to claim 2, characterized in that:
the first signal further includes a first data frame, the third signal includes a third data frame, and the slave communication device receives the first data frame and sends part or all of the data contained in the first data frame to the downstream device by including the data in the third data frame.

15. The slave communication device according to claim 2, characterized in that:
the peripheral interface module is connected to an external device, the third signal includes a third data frame, and the slave communication device receives data from the external device and sends part or all of the data to the downstream device by including the data in the third data frame.

16. The slave communication device according to claim 2, characterized in that:
the peripheral interface module is connected to an external device, the first signal further includes a first data frame, the third signal includes a third data frame, the slave communication device receives the first data frame and data from the external device, and sends part or all of the data contained in the first data frame and part or all of the data received from the external device to the downstream device by including the data in the third data frame.

17. The slave communication device according to claim 2, characterized in that:
the peripheral interface module is connected to an external device, the fourth signal includes a fourth data frame, and the slave communication device receives the fourth data frame and sends part or all of the data contained in the fourth data frame to the external device.

18. The slave communication device according to claim 2, characterized in that:
the second signal includes a second data frame, the fourth signal includes a fourth data frame, and the slave communication device receives the fourth data frame and sends part or all of the data contained in the fourth data frame to the upstream device by including the data in the second data frame.

19. The slave communication device according to claim 3, characterized in that:
the second signal includes a second data frame, and the slave communication device receives data from the external device and sends part or all of the data to the upstream device by including the data in the second data frame.

20. The slave communication device according to claim 2, characterized in that:
the peripheral interface module is connected to an external device, the second signal includes a second data frame, the fourth signal includes a fourth data frame, the slave communication device receives the fourth data frame and data from the external device, and sends part or all of the data contained in the fourth data frame and part or all of the data received from the external device to the upstream device by including the data in the second data frame.

21. The slave communication device according to claim 1, characterized in that:
the second signal includes a synchronization response frame, and the upstream device interface module sends the synchronization response frame to the upstream device within a preset time after receiving the synchronization frame.

22. The slave communication device according to claim 21, characterized in that:
after receiving the synchronization frame, the upstream device interface module sends the synchronization response frame to the upstream device earlier than any other data sent to the upstream device.

23. The slave communication device according to claim 2, characterized in that:
the fourth signal includes a synchronization response frame, and after sending the synchronization frame included in the third signal, the slave communication device judges the state of the downlink according to whether the synchronization response frame included in the fourth signal is received within a preset time.

24. A master communication device, comprising a host interface module, a downstream device interface module and a local clock generation module, characterized in that:
the host interface module is connected to a host, and the host interface module receives a data frame synchronization signal from the host;
the downstream device interface module is connected to a downstream device via a downlink, the downstream device interface module sends a first signal to the downstream device via the downlink, the downstream device sends a second signal, and the downstream device interface module receives the second signal from the downstream device via the downlink;
the first signal includes a synchronization frame, the downstream device interface module sends the synchronization frame, the synchronization frame contains data frame synchronization signal information, and the downstream device can recover the data frame synchronization signal according to the synchronization frame;
the local clock generation module generates a local clock, and the clock for the downstream device interface module to send the first signal is the local clock;
the first signal and the second signal are transmitted on the downlink in a time-division manner.

25. The master communication device according to claim 24, characterized in that:
the ratio of the frame frequency of the synchronization frame to the frequency of the data frame synchronization signal is M/N, where M and N are both positive integers.

26. The master communication device according to claim 25, characterized in that:
the synchronization frame includes a sequence number field, and the sequence number field contains a sequence number of the synchronization frame.

27. The master communication device according to claim 24, characterized in that:
the synchronization frame includes a phase field, and the phase field contains phase relationship information between the synchronization frame and the data frame synchronization signal.

28. The master communication device according to claim 24, characterized in that:
the synchronization frame includes a phase field and a counting field, the phase field contains phase relationship information between the synchronization frame and the data frame synchronization signal, and the counting field contains a count value of the data frame synchronization signal.

29. The master communication device according to claim 28, characterized in that:
the frame frequency of the synchronization frame is independent of the frequency of the data frame synchronization signal.

30. The master communication device according to claim 24, characterized in that:
the first signal includes a first data frame, and the master communication device receives data from the host and sends part or all of the data to the downstream device by including the data in the first data frame.

31. The master communication device according to claim 24, characterized in that:
the second signal includes a second data frame, and the master communication device receives the second data frame and sends part or all of the data contained in the second data frame to the host.

32. The master communication device according to claim 24, characterized in that:
the master communication device does not send any data to the downstream device within a preset time after sending the synchronization frame.

33. The master communication device according to claim 24, characterized in that:
the second signal includes a synchronization response frame, and after sending the synchronization frame, the master communication device judges the state of the downlink according to whether the synchronization response frame is received within a preset time.

34. The master communication device according to claim 24, characterized in that:
the master communication device is an integrated circuit chip, the local clock generation module generates the local clock according to a local reference clock, and the local reference clock is generated by an on-chip crystal-free reference clock generation circuit of the integrated circuit chip.

35. A master communication device, comprising a downstream device interface module, a data frame synchronization signal generation module and a local clock generation module, characterized in that:
the data frame synchronization signal generation module generates a data frame synchronization signal;
the downstream device interface module is connected to a downstream device via a downlink, the downstream device interface module sends a first signal to the downstream device via the downlink, the downstream device sends a second signal, and the downstream device interface module receives the second signal from the downstream device via the downlink;
the first signal includes a synchronization frame, the downstream device interface module sends the synchronization frame, the synchronization frame contains data frame synchronization signal information, and the downstream device can recover the data frame synchronization signal according to the synchronization frame;
the local clock generation module generates a local clock, and the clock for the downstream device interface module to send the first signal is the local clock;
the first signal and the second signal are transmitted on the downlink in a time-division manner.

36. The master communication device according to claim 35, characterized in that:
the ratio of the frame frequency of the synchronization frame to the frequency of the data frame synchronization signal is M/N, where M and N are both positive integers.

37. The master communication device according to claim 36, characterized in that:
the synchronization frame includes a sequence number field, and the sequence number field contains a sequence number of the synchronization frame.

38. The master communication device according to claim 35, characterized in that:
the synchronization frame includes a phase field, and the phase field contains phase relationship information between the synchronization frame and the data frame synchronization signal.

39. The master communication device according to claim 35, characterized in that:
the synchronization frame includes a phase field and a counting field, the phase field contains phase relationship information between the synchronization frame and the data frame synchronization signal, and the counting field contains a count value of the data frame synchronization signal.

40. The master communication device according to claim 39, characterized in that:
the frame frequency of the synchronization frame is independent of the frequency of the data frame synchronization signal.

41. The master communication device according to claim 35, characterized in that:
the first signal includes a first data frame, the master communication device generates data based on the data frame synchronization signal, and the master communication device sends the generated data to the downstream device by including the data in the first data frame.

42. The master communication device according to claim 35, characterized in that:
the second signal includes a second data frame, and the master communication device receives the second data frame.

43. The master communication device according to claim 35, characterized in that:
the master communication device further comprises a host interface module, the host interface module is connected to a host, and the host interface module sends the data frame synchronization signal to the host.

44. The master communication device according to claim 43, characterized in that:
the first signal includes a first data frame, the host generates data based on the data frame synchronization signal, and the master communication device receives data from the host and sends part or all of the data to the downstream device by including the data in the first data frame.

45. The master communication device according to claim 43, characterized in that:
the second signal includes a second data frame, and the master communication device receives the second data frame and sends part or all of the data contained in the second data frame to the host.

46. The master communication device according to claim 35, characterized in that:
the master communication device does not send any data to the downstream device within a preset time after sending the synchronization frame.

47. The master communication device according to claim 35, characterized in that:
the second signal includes a synchronization response frame, and after sending the synchronization frame, the master communication device judges the state of the downlink according to whether the synchronization response frame is received within a preset time.

48. The master communication device according to claim 35, characterized in that:
the master communication device is an integrated circuit chip, the local clock generation module generates the local clock according to a local reference clock, and the local reference clock is generated by an on-chip crystal-free reference clock generation circuit of the integrated circuit chip.

49. A half-duplex data communication system, comprising a first communication device and a second communication device, where the first communication device is connected to the second communication device via a communication link, characterized in that:
the first communication device includes a downstream device interface module, which sends a first signal to the second communication device via the communication link and receives a second signal from the second communication device via the communication link;
the second communication device includes an upstream device interface module, which sends the second signal to the first communication device via the communication link and receives the first signal from the first communication device via the communication link;
the first signal includes a synchronization frame, and the second communication device receives the synchronization frame;
the second communication device further includes a data frame synchronization signal recovery module, which recovers a data frame synchronization signal according to the received synchronization frame;
the first communication device and the second communication device each further include a local clock generation module, the clock for the first communication device to send the first signal is a local clock of the first communication device generated by the local clock generation module included in the first communication device, the clock for the second communication device to send the second signal is a local clock of the second communication device generated by the local clock generation module included in the second communication device;
the first signal and the second signal are transmitted on the communication link in a time-division manner.

50. The data communication system according to claim 49, characterized in that:
the first communication device is a master communication device, and the second communication device is a slave communication device.

51. The data communication system according to claim 50, characterized in that:
the first communication device does not send any data to the downstream device within a preset time after sending the synchronization frame.

52. The data communication system according to claim 49, characterized in that:
both the first communication device and the second communication device are slave communication devices.

53. The data communication system according to claim 49, characterized in that:
the second communication device further includes a peripheral interface module, the peripheral interface module is connected to an external device, and the peripheral interface module communicates with the external device based on the data frame synchronization signal.

54. The data communication system according to claim 53, characterized in that:
the peripheral interface module communicating with the external device based on the data frame synchronization signal includes that the peripheral interface module sends data to the external device, or receives data from the external device, or sends data to the external device and receives data from the external device based on the data frame synchronization signal.

55. The data communication system according to claim 53, characterized in that:
the peripheral interface module communicating with the external device based on the data frame synchronization signal includes that the peripheral interface module sends the data frame synchronization signal to the external device.

56. The data communication system according to claim 49, characterized in that:
the second signal includes a synchronization response frame, and the second communication device sends the synchronization response frame to the first communication device within a preset time after receiving the synchronization frame.

57. The data communication system according to claim 56, characterized in that:
after receiving the synchronization frame, the second communication device sends the synchronization response frame to the first communication device earlier than any other data sent to the first communication device.

58. The data communication system according to claim 56, characterized in that:
after sending the synchronization frame included in the first signal, the first communication device judges the state of the communication link according to whether the synchronization response frame included in the second signal is received within a preset time.

59. The data communication system according to claim 49, characterized in that:
the ratio of the frame frequency of the synchronization frame to the frequency of the data frame synchronization signal is M/N, where M and N are both positive integers;
the data frame synchronization signal recovery module recovers the data frame synchronization signal according to the timing signal of the received synchronization frame.

60. The data communication system according to claim 59, characterized in that:
the synchronization frame includes a sequence number field, the sequence number field contains a sequence number of the synchronization frame;
the data frame synchronization signal recovery module recovers the data frame synchronization signal according to the sequence number field and the timing signal of the received synchronization frame.

61. The data communication system according to claim 49, characterized in that:
the synchronization frame includes a phase field, the phase field contains phase relationship information between the synchronization frame and the data frame synchronization signal;
the data frame synchronization signal recovery module recovers the data frame synchronization signal according to the phase field.

62. The data communication system according to claim 49, characterized in that:
the synchronization frame includes a phase field and a counting field, the phase field contains phase relationship information between the synchronization frame and the data frame synchronization signal, and the counting field contains a count value of the data frame synchronization signal;
the data frame synchronization signal recovery module recovers the data frame synchronization signal according to the phase field and the counting field.

63. The data communication system according to claim 62, characterized in that:
the frame frequency of the synchronization frame is independent of the frequency of the data frame synchronization signal.

64. The data communication system according to claim 49, characterized in that:
the first communication device is an integrated circuit chip, the local clock generation module included in the first communication device generates the local clock of the first communication device according to a local reference clock of the first communication device, and the local reference clock of the first communication device is generated by an on-chip crystal-free reference clock generation circuit of the integrated circuit chip included in the first communication device.

65. The data communication system according to claim 49, characterized in that:
the second communication device is an integrated circuit chip, the local clock generation module included in the second communication device generates the local clock of the second communication device according to a local reference clock of the second communication device, and the local reference clock of the second communication device is generated by an on-chip crystal-free reference clock generation circuit of the integrated circuit chip included in the second communication device.
